(19) United States
(12) Patent Application Publication
(10) Pub. No.: US 2004/0098367 A1
(43) Pub. Date: May 20, 2004

(54) Across platform and multiple dataset molecular classification

(75) Inventors: Pablo Tamayo, Cambridge, MA (US); Jill P. Mesirov, Belmont, MA (US); Todd Golub, Newton, MA (US)

Correspondence Address: ROPES & GRAY LLP, ONE INTERNATIONAL PLACE, BOSTON, MA, 02110-2624, US

(73) Assignees: Whitehead Institute for Biomedical Research, Cambridge, MA; Dana-Farber Cancer Institute, Boston, MA

(21) Appl. No.: 10/636,481

(22) Filed: Aug. 6, 2003

Related U.S. Application Data
(60) Provisional application No. 60/401,591, filed on Aug. 6, 2002.

(51) Int. Cl. G06F 7/00

(52) U.S. Cl. 707/1

(57) ABSTRACT

Systems and methods for across platform and multiple dataset classification. In one embodiment the systems combine a Large Bayes classification framework, constructed from discovered itemsets or common patterns of data, with a definition of combined relative features to represent the original values. One realization of this method is that different datasets representing the same biological system display some amount of invariant biological characteristics independent of the idiosyncrasies of sample sources, preparation and the technological platform used to obtain the measurements. These invariant biological characteristics, when captured and exposed, can provide the basis to build robust, general and accurate classification models based on reproducible biological behavior

### CLAIM OF PRIORITY

This application claims priority to U.S. Provisional Application U.S. Ser. No. 60/401,591, filed 6 Aug. 2002, entitled Across Platform and Multiple Dataset Molecular Classification, the contents of which are hereby incorporated by reference in the entirety.

### BACKGROUND

The widespread use of microarrays, the refinement of protocols and the relative success of molecular classification has produced a significant increase in the number of publicly available gene expression datasets. A potential benefit of this is the larger number of samples for analysis and a better representation of disease phenotypes and biological systems of interest. At the same time there is a significant technical challenge in how to deal with the associated variability coming from the use of different technologies, platforms and increased heterogeneity of the sources of material. In this context there are two important situations of special relevance: across platform and combined multiple dataset classification.

At present there is a need in the Art for systems and methods that allow for across platform classification and allow for multiple dataset classification.

### SUMMARY

Described herein are systems and methods for across platform and multiple dataset classification. In one embodiment the systems described herein combine a Large Bayes classification framework, constructed from discovered itemsets or common patterns of data, with a definition of combined relative features to represent the original values. One realization of this method is that different datasets representing the same biological system display some amount of invariant biological characteristics independent of the idiosyncrasies of sample sources, preparation and the technological platform used to obtain the measurements. These invariant biological characteristics, when captured and exposed, can provide the basis to build more robust, general and accurate classification models based on reproducible biological behavior and are understood to be less vulnerable to process idiosyncrasies and technological details. As such, the systems and methods described herein filter out underlying biology from the collected data to thereby provide more robust classification models.

Thus, in one particular application, the systems and methods described herein may be employed for classifying and analyzing biological data, including, but not limited to, gene expression data, protein-protein interaction data, metabolic activity, immune response data or any other data representative of biological activity or compounds.

Presented herein are results for several across-platform datasets including one where the training of the model is done on oligonucleotide (Affymetrix Hu6800) and the testing on cDNA microarrays. Also described are results for a combined 4-class adenocarcinoma datasets incorporating 440 samples from six different original datasets using three platforms (oligonucleotide, cDNA and inkjet microarrays). Despite the different technologies, sample sources and the reduced overlapping feature sets, the presented methodology provides processes that allow for the construction of a global Large Bayes model attaining about 94% accuracy. This demonstrates the ability to create accurate classifiers based on large combined datasets of data, including gene expression data, protein data, metabolic data, and other types of data. It also provides a method to build global classification models that exploit databases of data, including, in one practice, gene expression data. These models can be used as part of a central facility to train models (e.g. tumor diagnosis and hospitals can join to form these database classification) that can then deploy to remote locations (hospitals and clinics).

More specifically, the systems and methods herein include methods for building classifiers. These methods can comprise merging a plurality of datasets representing data associated with a selected biological system. The biological system can be a cell, a tissue sample, a organism, or any other biological system and the biological system selected will depend upon the application at hand. The methods described herein, in some embodiments, process the datasets to identify an invariant characteristic of the selected biological system, representative of an identifying characteristic of the biological system. The methods employ the invariant characteristic to generate a model for classifying datasets or for discovering classes. In a further step the methods may generate the model based on a large bayes prediction process for determining the probability that a sample set is associated with one or more classes know to the method.

In another aspect the inention provices a method for building models for diagnosing a disease. The method may include accessing data from a plurality of remote databases, each having datasets representing data associated with a selected biological system. The method can process the datasets to identify an invariant characteristic of the selected biological system that is representative of an identifying characteristic of the biological system. The method employs the invariant characteristic to generate a model for classifying sample datasets as belonging to a first or second class, and applies sample data to the generated model to determine whether the sample data is associated with at least one of the first and second classes.

In a further embodiment, the invention provides a system for building classifiers that comprises a plurality of datasets representing data associated with a selected biological system, a processor for processing the datasets to identify and invariant characteristic of the selected biological system, representative of an identifying characteristic of the biological system, and a model generator capable of employing the invariant characteristic to generate a model for associating a sample dataset with a classification.

Other objects of the invention will, in part, be obvious, and, in part, be shown from the following description of the systems and methods shown herein.

### BRIEF DESCRIPTION OF THE DRAWINGS

The foregoing and other objects and advantages of the invention will be appreciated more fully from the following further description thereof, with reference to the accompanying drawings wherein;

FIGS. 1 and 2 depict schematically two processes according to the invention;

FIG. 3 depicts in more detail one process according to the invention;

FIGS. 4 and 5 depict examples of a pattern recognition process suitable for use with the systems and methods described herein; and

FIGS. 6-9 depict examples of results achieved through application of the systems and methods described herein.

### DESCRIPTION OF CERTAIN EMBODIMENTS

To provide an overall understanding of the invention, certain illustrative embodiments will now be described, including a method for discovering common patterns within a dataset, such as a set of gene expression data. However, it will be understood by one of ordinary skill in the art that the systems and methods described herein can be adapted and modified for other suitable applications, such as for building classification models and for building systems that aggregate different types of datasets from a plurality of different sources, and to provide a central facility where models may be trained and that such other additions and modifications will not depart from the scope hereof.

Due to the widespread use of microarray technologies, the refinement of experimental protocols and the relative success of molecular classification and data analysis of microarray data, there is today a significant increase in the number of publicly available gene expression datasets. Almost every new paper reporting results obtained by gene expression analysis provides an associated dataset. These datasets correspond to many common biological systems of interest (tumors, disease vs. normal comparisons etc.) but have been obtained with diverse technology platforms (e.g. cDNA, oligonucleotide arrays, etc) and using diverse sources of biological materials (hospitals, tumor banks etc.).

A potential benefit of this increased availability of datasets is the larger number of samples for analysis and the better representation of a particular phenotype or biological system of interest. At the same time there is a significant technical challenge in how to deal with the associated variability coming from the use of different technologies, platforms and potential increased heterogeneity of the sources of material. All this creates opportunities but also poses technical challenges. For example, one would think that the existence of five Lung Cancer datasets rather than one will have implications for the molecular classification of Lung Cancer samples in terms of an increase in the robustness, quality and significance of marker genes, an increase in the accuracy of a predictive model, better validation of supervised and unsupervised models, better definition of discovered subclasses, and more faithful projections of the data by Principal Component Analysis (PCA). However, the ability to realize the benefits of having multiple datasets, turns at least in part, the ability to draw inferences out of these multiple datasets, without concern that differences among the datasets will lead to false results.

There are two situations in molecular classification of particular interest:

Across platform classification.—Training a classifier in a dataset obtained by using one technology platform (e.g. oligonucleotide microarrays) and applying this model to predict samples from a test set obtained by a different technology (e.g. cDNA microarrays). This is useful for example to validate a model or to develop a centrally trained universal model to be used and deployed on different, not already existing, datasets.

Multiple dataset classification.—Combining several datasets potentially representing different platforms or source material and building a global unified classification model. This model benefits from an increased sample size and also from the potential richness of the combined dataset.

The systems and methods described herein solve both of these problems based in one embodiment, on defining relative features and using them in a Large Bayes classification framework. As discussed above, one of the assumptions is that different datasets representing the same biological system display some amount of invariant biological characteristics independent of the idiosyncrasies of sample sources, preparation or the technological platform used. These invariant biological characteristics, if captured and exposed by the relative features, provide the basis to build more robust, general and accurate classification and class discovery models based on reproducible biologically behavior and are less vulnerable to idiosyncrasies and technological details particular to each individual project or dataset.

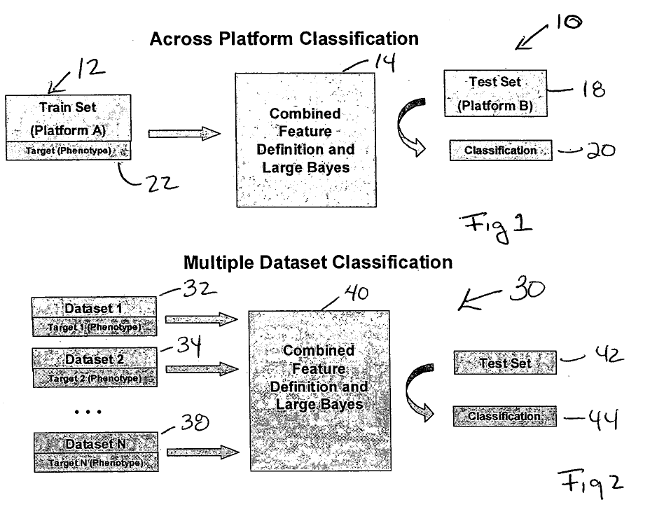

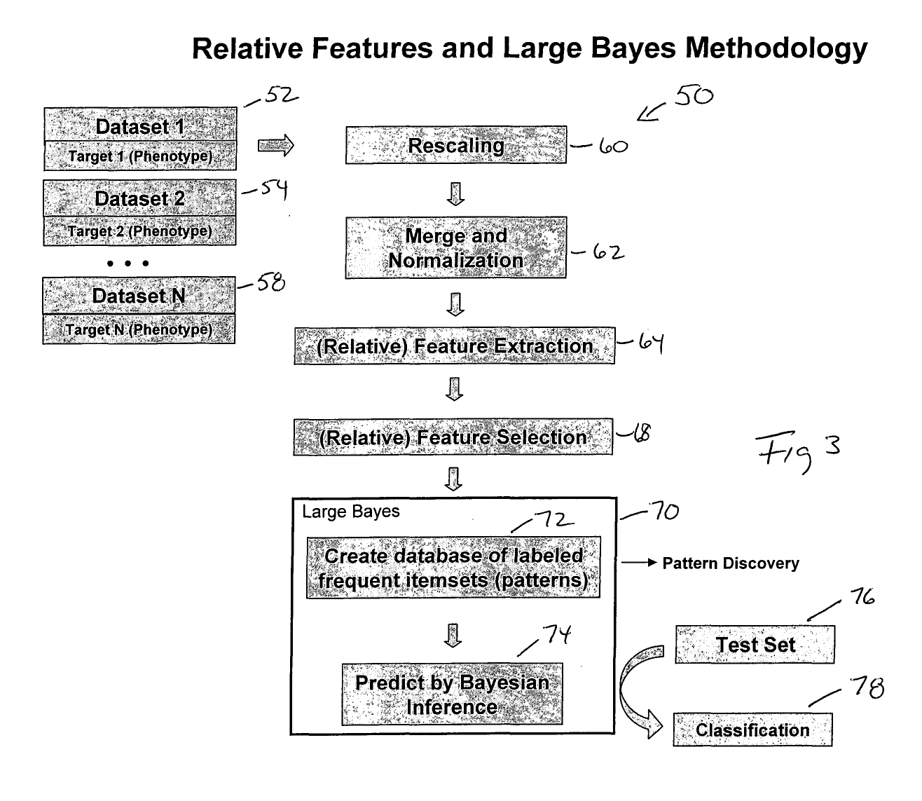

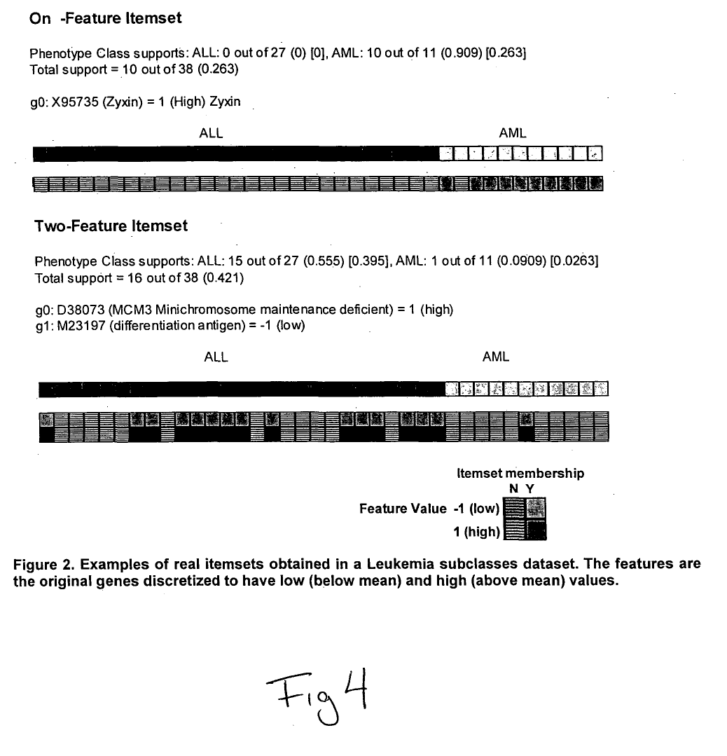

FIGS. 1 and 2 depict respectively the different applications of the systems and methods described herein. Specifically, FIG. 1 depicts a first application of the system and methods described herein wherein the systems and methods are employed for across platform classification. Specifically, FIG. 1 depicts graphically a process 10 wherein a training set of data captured using a first platform (platform A) is employed to create a classification system 14 that includes a set of combined feature definitions developed from trainset 12 and has a large base inference model capable of using those definitions to determine different classifications. To this end, FIG. 1 depicts that the classification system 14 may be used on a test set of data 18 that was collected using a different type of platform (platform B) and still a classification 20 determination can result. Thus the system and methods described herein provide for combined feature definitions and inference engines that are capable of being trained with data derived from a first platform, such as a cDNA system and subsequently used for test data that was actually gathered with a different type of platform.

Turning to FIG. 2 a second application of the systems and methods described herein is shown pictorially. Specifically, FIG. 2 depicts a process where multiple dataset classification wherein as part of that process 30 a plurality of datasets 32, 34 and 38 are applied to and used to generate the classification system 40 that has a combined feature definition and a large bayes inference and classification system that can be used on a test set of data 42 for determining classifications to associate with that test data.

In the context of across platform and multiple dataset classification of gene expression data there are several technical challenges to overcome:

Different (only partially overlapping) features (gene) sets

Different probes for the same genes

Different Technologies (e.g. Affymatrix vs. cDNA etc.)

Different releases of same technology

Higher variability of biological material

Different sources of biological materials (hospitals and laboratories)

Different experimental protocols for sample and target preparation

Different dynamic ranges and measurements (settings, calibration etc.)

Different empirical distribution function

How to expose the invariant biology in a classification model

The methods described below solve many of these problems. They combine the use of relative features with a Large Bayes classifier to provide a powerful and general classification model that works across different datasets. In addition the methods provide an intermediate representation of the data based on common occurrences (itemsets) useful for pattern discovery. The methods provide the capability to, among other things.

Perform across platform classification in which the model is trained in a dataset corresponding to one technology (e.g. oligonucleotide microarrays) and then is applied to a test dataset from a different technology (e.g. cDNA microarrays). The test dataset can contain as low as one sample and have a small feature set overlap with the train set (as low as one gene in common).

Build a classification model built on top of multiple datasets corresponding to different platforms, different sources of material or obtained at different times, etc. This has to potential to build universal models with very large sample sizes as results of the combination of many datasets.

Define relative features that may expose biological invariants in the form of gene-to-gene relationships. The relative features are used as inputs to the Large Bayes classifier but also provide a powerful approach to marker selection where the markers are not individual genes but combinations. In addition a relative feature marker can be selected by its partial rather than total correlation with the target phenotype.

Provide an intermediate representation and pattern discovery. Perform prediction and inference in a two-step process in which the dataset is first converted into an intermediate representation (itemsets) useful for pattern discovery and unsupervised learning. This representation can be pre-computed and become the starting point of different types of analysis (pattern selection, clustering, classification etc.). The prediction of test samples is done, in one practice, by a Bayesian product of probabilities consistent with the relative features observed in the test sample. This two-step process and the adaptability of the inference step gives the method flexibility and by making the process model building and prediction process transparent it is technically and theoretically appealing.

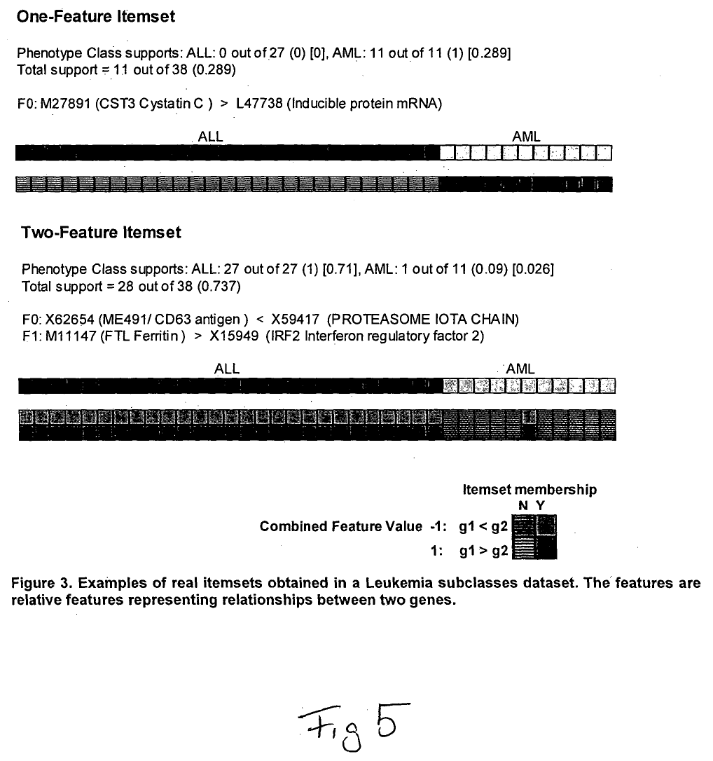

FIG. 3 depicts a diagram of one process 50 that allows for extracting relative features from a plurality of datasets and using large bayes methodology for classification of test set data.

Specifically, the process 50 depicted in FIG. 3 operates on a plurality of different datasets, 52, 54 and 58. In one particular embodiment each of the datasets 52, 54 and 58 contain information about a specific biological system. For example, the datasets can include gene expression data, protein-protein interaction data, metabolic data, or other kinds of information about a biological system. In the embodiment wherein gene expression data is captured within the datasets, each of these different datasets can include expression data that was captured on different kinds of platforms, from different sources of materials or materials processed at different times, or in some way can have variations. The process 50 will define relative features that expose the biological invariance of the biological system of interest.

To this end, the datasets 52, 54 and 58 can be applied to the process 50 in a step 60 that rescales the information. Any suitable resealing process can be used for rescaling the expression data and the systems and methods described herein don't rely on or are not tied to any particular rescaling technique. Generally, the operation of rescaling is used to compress or expand the profiles so that each of the different datasets are represented with the same scale, for example 0 to 1 or −1 to 1. However, it will be understood that the overall shape of the profile and the different information stored in the gene expression profiles of the different datasets will be maintained, although presented according to a new scale.

Once the data has been rescaled the process 50 proceeds to operation 62 wherein the datasets are merged and normalized. In one operation, the different datasets are merged together from a common feature overlap set is identified and maintained. The process can then operate on the common feature overlap set and to this end the process 50 can normalize the different columns, either standardizing the columns or optionally replacing values with their ranks. This process of merging and normalization is applied in the application shown in FIG. 2 wherein multiple datasets are being employed to develop the combined feature definition. This process is not typically required for across platform classification where multiple datasets are not being employed to determine the combined feature definitions.

Once the data has been merged and normalized the process 50 proceeds to operation 64 wherein a relative feature abstraction process takes place. This relative feature abstraction process, which will be described in more detail hereinafter, yields a definition that provides new features that capture gene-to-gene relations regardless of the precise absolute values of the gene expression data or the existence of other genes in the feature set. Thus, this definition provides a representation at a higher level of abstraction than the detailed gene expression values. However, as will also be shown hereinafter, this higher level representation or more abstract representation does not prevent the Bayes classifier from obtaining a high precision class prediction model that yields low error rates. Thus, it is understood that the abstract relative feature effectively capture the relevant and variant biological information that can be used to classify samples.

Once the relative feature abstraction process in performed the process 50 moves to the operation 68 wherein a set of the relative features is selected for use and for presenting to the large Bayes classifier. Any suitable technique for feature selection may be employed, and particular practices are described in more detail hereinafter. In one embodiment, the feature selection process identifies patterns of a feature that appear to occur commonly within the collected dataset information. These collected patterns may be employed to create the large Bayes classifier 70 shown in FIG. 3. To this end, the selected features may be stored to create a database of known features. Once these known features are identified a prediction process 74 may be used for employee these identified features to determine the likelihood or the probability that certain test data, such as the depicted test data 76 belongs to a particular classification 78. In one particular practice, the prediction model uses a Bayesian inference model for determining the probability that a particular set of test data should be associated with a particular classification. However, other prediction processes may be employed without departing from the scope hereof.

The depicted process 50 may be realized as a software component or several components operating on a conventional data processing system such as a Unix workstation. In that embodiment, the process 50 can be implemented as a C language computer program, or a computer program written in any high level language including C++, Fortran, Java or BASIC. Additionally, in an embodiment where microcontrollers or DSPs are employed, the process 50 can be realized as a computer program written in microcode or written in a high level language and compiled down to microcode that can be executed on the platform employed, such as an embedded system. The development of such systems is known to those of skill in the art, and such techniques are set forth in Digital Signal Processing Applications with the TMS320 Family, Volumes I, II, and III, Texas Instruments (1990). Additionally, general techniques for high level programming are known, and set forth in, for example, Stephen G. Kochan, Programming in C, Hayden Publishing (1983). It is noted that DSPs are particularly suited for implementing signal processing functions, including preprocessing functions such as data enhancement for the purpose of addressing signal to noise ratios. Developing code for the DSP and microcontroller systems follows from principles well known in the art. The large Bayesian classifier can include a database, as described above, and the database can be a flat file or can be any suitable database system, including the commercially available Microsoft Access database, and can be a local or distributed database system. The design and development of suitable database systems are described in McGovern et al., A Guide To Sybase and SQL Server, Addison-Wesley (1993).

These software processes may be executed on a conventional data processing platform such as an IBM PC-compatible computer running the Windows operating systems, or a SUN workstation running a Unix operating system. Alternatively, the data processing system can comprise a dedicated processing system that includes an embedded programmable data processing system that can include the microarray analysis system. In embedded programmable devices, the processes described herein may be implemented in hardware, software or a combination of both. Other configurations of the systems described herein will be apparent to those of skill in the art.

### Relative Features

There are several methods to provide dataset normalization across platforms for train and test purposes or to merge multiple datasets. One initial step is to map the features names or accession numbers from one platform to another. In this way, like features from one data set can be associated with like features in another dataset. The datasets can be normalized and some strategies to normalize the data across datasets are:

Rank column normalization. Replace expression values by their ranks column-wise.

Column standardization. Standardize expression values column-wise.

Relative features. Find gene-pair ratios (e.g. gₓ/g_{y}) or logical relative features (e.g. gₓ>g_{y}) and use them instead of the original variables. One can also find “higher order” combinations of those features (itemsets) and use them instead of the original variables.

The first two strategies employ a global computation of the ranks, or means, and therefore employ the explicit computation and use of the overlap feature set. These two provide a first approximation to address the problem of across platform normalization. In the last strategy the new feature set is based on gene-to-gene pair relationships: one gene acts as a control for another. This is a potentially powerful approach as it does not even have to define the overlap set. In our methodology we will define relative features (Fₖ) based on comparing the gene expression values of gene pairs. For example for two genes f₁ and f₂ we define:

Fₖ=1 if f₁>f₂ −1 if f₁<f₂

If this is repeated for many genes we can generate a set of relative features that represent gene relationships present and characteristic of the samples in the dataset:

| | | Relative |
|---|---|---|
| Original features fᵢ | Relationship between features | feature Fₖ |
| gene 1 = 1000, gene 2 = 500 | gene 1 > gene 2 | 1 |
| gene 3 = 50, gene 4 = 800 | gene 3 < gene 4 | −1 |
| gene 5 = 300, gene 6 = 10 | gene 5 > gene 6 | 1 |
| gene 2 = 500, gene 3 = 50 | gene 2 > gene 3 | 1 |
| . . . | . . . | . . . |

This definition provides new features that capture gene-to-gene relationships substantially independently of the precise absolute values of gene expression or the existence of other genes in the feature set. One gene acts a control for another one. These local, binary, relative features provide a first level abstraction of gene relationships and certainly do not preserve some of the information contained in the original gene expression values. As we will see later this does not prevent a classifier from attaining low error rates implying that the relative features effectively capture the relevant invariant biological information needed to classify samples. This higher abstraction from detailed gene expression values allows the relative features to be used as markers across platforms or across a diverse set of datasets.

### Frequent Itemsets

In one practice the process uses a Large Bayes classifier that in turn is based on performing Bayesian inference and classification using a set of computed features called itemsets. These itemsets are combinations of original feature's discretized values that are observed to take place often. Itemsets represent pockets of feature correlations or common occurrences in the data. Itemsets are known in the Art and were introduced (Srikant and Agrawal 1995) is the problem of “market basket” analysis. In this problem one is interested in finding frequent purchases of collections of groceries to help uncover common but non-trivial trends in shopping. For example consider the following collection of shopping baskets form a supermarket:

Shopper 1 basket: oranges, lemons, cheese.

Shopper 2 basket: granola bar, ketchup, limes.

Shopper 3 basket: chocolate, apples, oranges, cream.

Shopper 4 basket: ketchup, eggs.

Shopper 5 basket: oranges, eggs, carrots, ketchup.

Shopper 6 basket: tuna fish, ketchup, eggs, onions.

Shopper 7 basket: ketchup, oranges, eggs, cheese, milk, onions, garlic.

Frequent Itemsets, itemsets above a “support” threshold in terms of number of occurrences, capture correlations that appear as repeated appearance of items in the baskets. For the baskets shown above if the support is set to be two occurrences (2/7=28% of the baskets), we find six frequent itemsets:

| | |
|---|---|
| {oranges} | (support = 4 of 7 baskets) |
| {onions} | (support = 2 of 7 baskets) |
| {eggs} | (support = 4 of 7 baskets) |
| {ketchup} | (support = 5 of 7 baskets) |
| {eggs, ketchup} | (support = 3 of 7 baskets) |
| {eggs, ketchup, onions} | (support = 2 of 7 baskets) |

For example, the fact that many shopper's baskets contain the combination of eggs AND ketchup AND onions with higher frequency than other three random items is perhaps not unexpected; however many combinations may not be trivial and discovering and exposing them is potentially valuable to a supermarket. The process of finding the frequent itemsets is sometimes called association discovery and is understood as an example of unsupervised learning. Typically a set of frequent itemsets is expressed as a set of simple logical (association) rules that represent the shopping trends and are used by a supermarket analyst to develop a better understanding of the data and the process that generate it. Itemsets can be found using well known and tested association rule algorithms developed by the data mining community over many years.

To define frequent itemsets for gene expression the process may discretize gene expression values. In the most extreme discretization the values will be made binary, for example, according to “high” and “low” values of expression. The threshold that separates high from low may be determined independently for each gene and can be based on the mean or median. More sophisticated discretization schemes that use the distribution of values can also be used. In this way for individual genes an itemset could be, for example, a combination of gene values or gene relationships exposing a common occurrence in the dataset. In this approach, the analogy is that biological sample is a “basket” that contains a number of items such as genes at different values of expression or gene relationships

Normal sample: gene 1=low, gene 2=high, . . . .

Tumor sample: gene 1=low, gene 2=low, . . . .

Or for relative features as we will see later:

Normal sample: gene 1>gene 2, gene 3<gene4, . . . .

Tumor sample: gene 1>gene 2, gene 3>gene4, . . . .

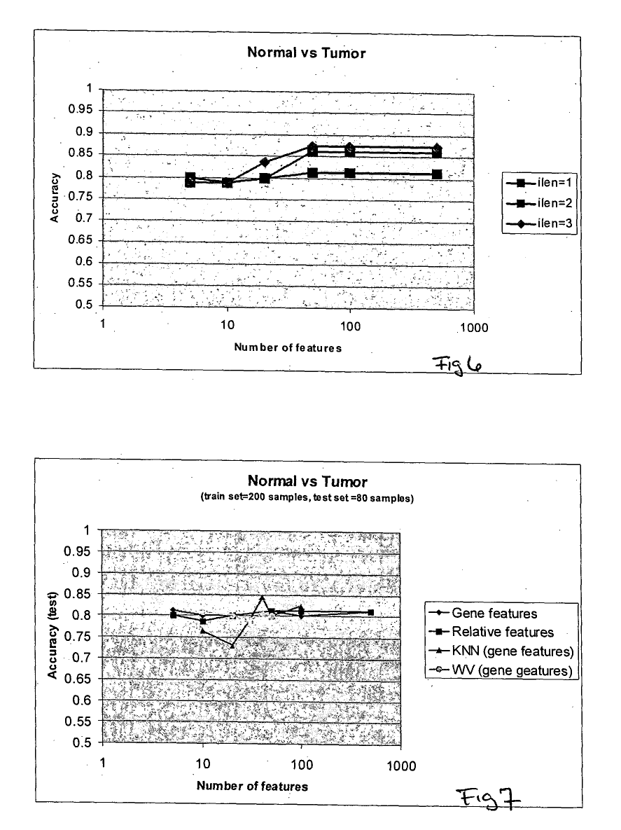

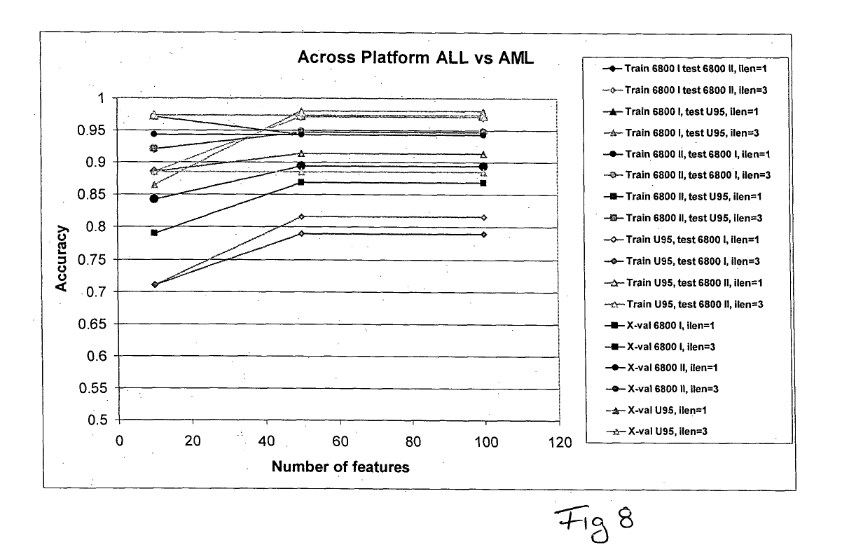

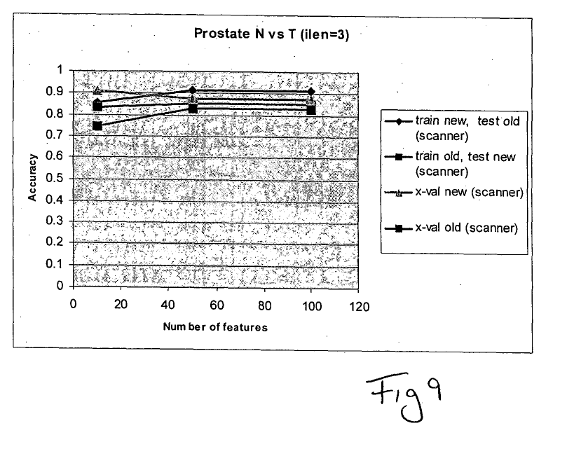

FIGS. 4 and 5 show pictorial representation of examples of real itemsets obtained in the Leukemia subclasses dataset. The ones in FIG. 4 are constructed using single-gene discretized features and the ones in FIG. 5 correspond to relative features.

In the context of pattern discovery, finding frequent itemsets can be used to uncover pockets of correlation within a data set. In contrast with a global algorithm, such as Principal Component Analysis (PCA), which attempts to model the entire data set as a whole, local algorithms do not require that a pattern hold throughout all of the data. Local algorithms build patterns from the bottom up and define an intermediate representation for subsets of the data that are highly correlated. Another advantage of itemsets is that they consider gene to gene correlations and can be used as markers and combined with several genes expression. Itemsets can also correlate only partially with the target class. This is particularly relevant in those cases where there are unknown subclasses within a given apparently homogenous phenotype class.

### Large Bayes Classification

Once patterns are extracted and selected, the patterns may be used to classify the collected datasets into different classes, and even subclasses. Any suitable classified may be used, but in preferred embodiments, the systems and methods described herein employ Large Bayes classification.

The idea behind the large Bayes method of classification is to use phenotype-labeled itemsets as input features to a Bayesian classifier as it is described in the next section.

Large Bayes is a classification algorithm that creates a context-specific probabilistic model of the data to estimate class membership of new samples. It can be seen as a less naïve version of Bayes in the sense that it uses itemsets rather than the original variables as input features. By using itemsets it takes into account feature correlations and can outperform naïve Bayes where each feature is assumed independent of all the others. To implement large Bayes, each of the itemsets in the training set is to be “labeled” according to its overlap with the phenotype labels. This process of labeling itemsets is a “training” process equivalent to training a supervised classifier. Once a database of labeled itemsets has been created the Large Bayes classification of new test samples is done by assembling a product approximation (Lewis 1959) to the posterior probability of each phenotype class using the test-sample “observed” itemsets. Finally the winning class may be chosen by comparing the posterior probabilities of the different phenotype labels. The motivation for this assumption is that correlated non-independent features should form frequent itemsets, otherwise they can be considered as independent. Large Bayes is an improvement over, but reduces to, naïve Bayes when itemsets containing one item are used. Large Bayes operates in two steps:

Find and label frequent itemsets. In this step it uses the apriori association discovery algorithm of Srikant and Agrawal to find frequent itemsets (above a given support threshold) in the training set. Then it labels them according to their overlap with the target labels of interest using contingency matrices similar to the one described in the relative feature selection section. The apriori algorithm is an efficient method to enumerate the itemsets above a threshold in a computational efficient way. The itemsets can be stored in a database where they can be used for different types of analysis or for the prediction of test samples as described below.

Prediction. Prediction may be done by matching itemsets and using a product approximation to estimate the joint probability of the sample and the target class labels in a Bayesian framework Given a new test sample to be classified:

A={a1, a3, a7, a9, a11},

it select the longest matching subsets of A in the database of itemsets produced by the previous step:

Matching itemsets={a1, a11}, {a3, a7}, {a3, a9}, {a3, a11}, {a7, a9, a11}

Then it incrementally constructs a product approximation to the joint probability P(A, Ci) adding one itemset at a time following chain probability rules to guarantee the approximation is valid and optional heuristic rules to favor long itemsets.

P(A, Ci)=P(Ci) P(a1, a11|Ci) P(a3|a11, Ci) P(a7|a3, Ci) P(a9|a7, a11, Ci)

Finally, the prediction is done according to which target class is the most probable one:

P(A, C1)>P(A, c2).

The Large Bayes approach has several interesting practical and theoretical appealing features and advantages. Meretakis et al. (2000) benchmarked this algorithm against other standard classification methods and obtained very good empirical results for a large collection of datasets. Meretakis and Wüthrich (1999b) have proposed labeled itemsets as a comprehensive representation and general framework for classification.

### Methodology

As described above, the methods may combine the use of relative features with a Large Bayes classifier. The main components of the methodology are shown pictorially in FIG. 3 and explained in more detail below.

### Thresholding and Rescaling

Apply any necessary thresholding or microarray rescaling to the train, test or multiple input datasets. This may be done in the standard way tailored to each platform or type of dataset. Filtering can be applied but its use has to be assessed in the context of multiple dataset classification. E.g. “flat” genes in one dataset may be expressed at significant values in another so one may want to exclude them. As the feature sets are only partially overlapping one may want to preserve the original features of each datasets as much as possible. As part of this step one also maps the feature set of the test set into the train set, for across platform classification, or maps the multiple dataset feature sets to a common overlap set.

### Merge and Normalize Columns

For the multiple datasets case merge the datasets and find the common feature overlap set. Then standardize each column or replace values with their ranks (considering only the common feature overlap set). This normalization is not central to the methodology and is only necessary for the multiple dataset classification case due to the use of a feature pre-selection process.

### Define Relative Features

First pre-select a subset of the original features by applying signal to noise marker selection. The signal to noise score (μ_{A}−μ_{B})/(σ_{A}+σ_{B}) selects features correlated with the phenotype labels (A, B). For more than two labels the procedure chooses the top features for each label as differentiated of all the others (one vs. all). This selection can be quite rough and it is mainly to reduce the computation of potentially millions of relative features (gene-pairs) most of which have low predictive value.

Then using the top P marker features (fᵢ}) (typically a few hundreds) applicants will define relative features (Fₖ) as was described before. For all combinations pairs f₁ and f₂ in P define:

Fₖ=1 if f₁>f₂ −1 if f₁<f₂

The total number of relative features produced is (P−1)P/2. As applicants mentioned before one motivation for this definition is to provide new features that capture gene-to-gene relationships and provide the Large Bayes classifier a more abstract representation of the data detached from the idiosyncrasies of each technology or specific dataset.

Notice that these combined features can in principle be even better markers than individual genes; however, as they can also be noisier it may be helpful to build the Large Bayes classifier using several of them.

### Combined Features Selection

From the set of combined features obtained in the last step select the set with the largest mutual information with the phenotype labels (MI(Fₖ, Tⱼ. The combined features are discrete (binary) and therefore the mutual information is a convenient choice of metric. Then the combined features are sorted according to their similarity with, in one practice, the phenotype classes determined as follows:

MI(Fₖ, Tⱼ)=ΣⱼΣₖ P(Fₖ, Tⱼ) log (P(Fₖ, Tⱼ)/P(Fₖ)P(Tⱼ))

Where P(Fₖ, Tⱼ), P(Fₖ) and P(Tⱼ) are the estimated joint and marginal probabilities computed from a contingency matrix of the cross tabulation of phenotype labels and each combined feature counts. The indices k and j runs over all values of the combined features (−1 and 1) and the phenotype labels (two or more). The contingency matrix for a combined feature and a phenotype class with two labels (e.g. normal and tumor) would look like this:

| | | Tⱼ | |
|---|---|---|---|
| | | Normal | Tumor |
| Fₖ | 1 | a | b |
| | −1 | c | d |

Where a, b, c, d are the number of samples observed with those feature values and phenotype labels. Then for example, P(F₀=1, T₂=Tumor) will be estimated by b/(a+b+c+d), etc., the Large Bayes algorithm will make similar tables to compute posterior probabilities for each class).

Given the way the combined features are created one would have gene participating P−1 times in the definition of combined features. As the large Bayes classifier assumes independence between the input features applicants will add the additional constraint of limiting gene participation to only c≦P−1 combined features, the ones with the highest mutual information. This reduces significantly the number of combined features and produces a less correlated set. In most experiments, c was set so c=1 and limit the contribution of each gene to one, typically the best, combined feature. A final set p of top combined features, typically 50 or 100 for morphological distinctions, is then used as inputs to the Large Bayes classifier.

In alternative practices, combined features with additional resolution in terms of having a third state to represent rough equality (gene 1≈gene2) or having multiple bins to record the fact that a relationship between two genes (gene 1>gene 2) was 2-, 3-, 4- fold etc. In these cases the additional sparseness in the contingency matrices, and associated increased error in estimating the marginal probabilities, ended up producing less stable and less accurate Large Bayes classifiers. However, with enough samples to reasonably populate the contingency matrices the resolution of the combined features can be increased.

### Large Bayes Classification

Once the top p combined features have been selected one can use the Large Bayes classifier in the training and testing paradigm of supervised learning. Cross-validation can also be used and it is preferred to perform the pre-selection, definition and selection of combined features inside the cross validation loop. Thus, the systems and processes used the original Large Bayes algorithm as described and implemented in Meretakis & Wüthrich (1999a, 1999b) and Meretakis et al (2000). The Large Bayes classifier two steps as performed as follows:

Create database of labeled frequent itemsets for the expression dataset. Find the frequent itemsets in the training set and label them according to their overlap with the phenotype labels of interest. These itemsets are stored in a database that represents the original data in a high-level more abstract representation that includes explicitly high correlations between the genes. For classification purposes this database is all that Large Bayes needs to predict new samples and the original dataset is not used. It will be interesting to study in the future the possibility of doing other types of analysis directly on top of the itemset database (clustering, projections, etc.)

Prediction of test samples. Given a new test sample, define the combined features and match their values against the database of labeled itemsets. Assemble a product approximation using those itemsets actually observed in the test sample and use them to compute the joint probability of the sample and each phenotype class.

The accuracy of the Large Bayes classifier is estimated in the standard way by computing error rates, confusion matrices etc.

Parameters may be changed when building the Large Bayes classifier (support, length or itemsets, entropy and interestingness filters, etc.). Examples below have explored those parameters in the context of several gene expression datasets and have found settings that produce robust and effective models with little need of model selection and the associated risk of overfitting. The default parameters are described in the examples. The two parameters that are left for experimentation are the number of features and the length of the itemsets. Typically the error rate will decrease with increasing number of combined features until it reaches a plateau. Adding more features does not harm the classifier. This characteristic may be beneficial in across platform classification when the number of overlapping combined features available in the test set is not known beforehand. Longer itemsets produce better classification in general but there is also a saturation effect. Typical gene expression datasets improve when the itemsets have length 2 or 3, compared with one, but the experiments demonstrate rarely itemsets longer than 3 are needed. When the length of the itemset is set to one (one pair-gene) Large Bayes becomes Naïve Bayes and provides a convenient benchmark against which one can compare the results with larger itemsets.

Besides its empirical success as a classifier the Large Bayes classification framework has several features for the analysis and classification of gene expression data this is true when using combined or original single-gene features:

It is a principled, theoretically sound and empirically well-tested general classification method.

It uses a “transparent” probabilistic model where the details of each prediction can easily be traced back to the original data.

It combines unsupervised (class discovery) and supervised learning in a single framework. It creates and intermediate representation of the data (itemsets database) useful for pattern discovery.

It is easy to train and fast. It tolerates missing values and works well with a small number of data points in a large number of dimensions;

It can discover unknown phenotype subclasses and use them as part of a the classifier.

### EXAMPLES

### Same Platform Classification

Applicants studied the characteristics of combined features and the Large Bayes classifier in a setting where the train and test datasets were obtained using the same platform. This was done to study the effect of changing several parameters in the Large Bayes classifier and to test whether the algorithm worked properly before applying it to more challenging cases involving across platform and multiple datasets classification. Applicants consider a first dataset containing a large number of tumor and normal samples:

### Example 1

### Dataset 1: Normal vs Tumor Distinction (Ramaswamy et al 2001)

### Train Set 200 Samples

### Test Set 80 Samples

### Affymetrix Hu6800 Oligonucleotide Microarrays

The methodology applicants applied is as described above. The dataset was thresholded, rescaled and a simple variation filter was applied to the data. In this case there is no need to map the test set features as they are identical to the training set.

After some initial exploration with the Large Bayes parameters the itemset were set to support to 0.30 and not filter the dataset using an interestingness and entropy filters. These filters are useful in general to limit the number of itemsets while retaining accuracy. The choice of 0.30 is based on those empirical results but also in the notion that a pattern captured by an itemset has to be observed in at least 30% of the samples of given phenotype label.

Once a reasonable setting of those basic parameters was decided one of the first questions addressed was to compare the use of combined features with the original single gene features, as a function of the number of combined features, when both were input to the same type of Large (Naive, itemset length=1) Bayes classifier. The results show that the combined features are as informative as the original ones to classify this dataset using a Large Bayes classifier. The accuracy is about 0.80 and it is flat as a function of the number of combined features: model from 5 to 1000 features perform similarly. FIG. 5 depicts graphically the results of the test.

Then applicants studied the effect of using longer itemsets (length=2, 3) as shown in FIG. 6. The longer itemsets increase the accuracy when larger numbers of features are used but the main contribution is from the length two itemsets. Longer than three itemsets did not appear to improve the accuracy of the model in this experiment.

Applicants also compared the 1=3 results with the ones obtained using other classifiers using the original singe gene features as inputs (see FIG. 7). The conclusion from that experiment and others is that Large Bayes classifier is comparable in performance to other algorithms such as k-nearest neighbors and weighted voting but shows more stable results as a function of input features. However, the classifier selected will depend, at least in part, on the application at hand, those of skill in the art will select a suitable classifier.

### Example 2

### Dataset 2

### Treatment Outcome in Medulloblastoma

### Affymetrix Hu6800, 7129 genes, 60 samples

This dataset was used to see if the methodology described herein will work in a harder classification problem such as predicting treatment outcome. The table below shows the performance for this experiment of the combined features and Large Bayes classifier as compared with the other classifiers discussed in Pomeroy et al 2002. Large Bayes produced results comparable to the other algorithms (e.g k-nearest neighbors, weighted voting and support vector machines (SVM)).

### Summary of Treatment Outcome prediction Performance

| | Total | Total |
|---|---|---|
| Algorithm | Correct | Errors |
| Staging | 41 | 19 |
| TrkC | 40 | 20 |
| Weighted Voting | 46 | 14 |
| SVM | 45 | 15 |
| k-nearest neighbors | 47 | 13 |
| SPLASH | 45 | 15 |
| Large Bayes | 44 | 16 |

### Across Platform Classification

### Example 2

### Leukemia Subclasses ALL/AML

### Dataset 1: Affymetrix Hu6800 22 samples, 7129 genes (Golub et al 1999)

### Dataset 2: Affymetrix Hu6800 28 samples, 7129 genes (Golub et al 1999)

### Dataset 3: Affymetrix U95, 52 samples, 12582 genes (MLL paper)

Large Bayes model with 50 combined features, itemset length=3 FIG. 8 depicts graphically the accuracy measures for across platform classification for ALL vs. AML.

| Type | Mode | Accuracy |
|---|---|---|
| x-val | Cross validation on dataset 1 | 0.8684 |
| x-val | Cross validation on dataset 2 | 0.9429 |
| x-val | Cross validation on dataset 3 | 0.9737 |
| train_test | Train on dataset 1, test on dataset 2 | 0.9714 |
| train_test | Train on dataset 1, test on dataset 3 | 0.9808 |
| train_test | Train on dataset 2, test on dataset 1 | 0.9474 |
| train_test | Train on dataset 2, test on dataset 3 | 0.9474 |
| train_test | Train on dataset 3, test on dataset 1 | 0.7895 |
| train_test | Train on dataset 3, test on dataset 2 | 0.8857 |

### Example 3

### Normal vs. Prostate (depicted in FIG. 9)

### Dataset 1: Affymetrix U95 new scanner settings, 102 samples, 12600 genes (Whitehead)

### Dataset 2: Affymetrix U95 old scanner settings, 35 samples, 12600 genes (Novartis)

### Example 4

### Lymphoma subclasses: DLBC vs. Follicular

### Dataset 1: Affymetrix Hu6800, 38 samples, 7129 genes (Shipp et al 2001)

### Dataset 2: Stanford cDNA, 18 samples, 1635 genes (Alizadeh et al 2001)

Large Bayes model with 50 combined features, length=3.

| | |
|---|---|
| Training on dataset 2 | Training on dataset 1 |
| Testing on dataset 1 | Testing on dataset 2 |

| | Actual | | | Actual | |
|---|---|---|---|---|---|
| Test set | DLBC | Follicular | Test set | DLBC | Follicular |
| Pred. DLBC | 14 | 5 | Pred. DLBC | 7 | 2 |
| Follicular | 1 | 18 | Follicular | 1 | 8 |

| | | | |
|---|---|---|---|
| llen = | 150 NB itemsets | llen-3, | 150-NB itemsets |
| 3,501 item- | | 12222 item- | |
| sets | | sets | |
| Total Accu- | | Total Accu- | |
| racy = 0.84 | | racy = 0.83 | |
| ROC Accu- | | ROC Accu- | |
| racy = 0.86 | | racy = 0.80 | |

### Multiple Dataset Classification

### Example 5

### 4-Class Adenocarcinoma dataset

This dataset was assembled by combining the following datasets:

| | Dataset: | | | | | | |
|---|---|---|---|---|---|---|---|
| | WI GCM | Novartis GCM | Rosetta | Stanford | WI Lung | WI Prostate | |
| | Type: | | | | | | |
| | Multi-tumor | Multi-tumor | Breast | Lung | Lung | Prostate | |
| | Platform: | | | | | | |
| | Affy Hu6800/35 k | Affy U95 | Inkjet | cDNA | Affy U95 | Affy U95 | Total |
| Breast | 11 | 26 | 78 | 0 | 0 | 0 | 115 |
| Prostate | 10 | 26 | 0 | 0 | 0 | 52 | 88 |
| Lung | 11 | 14 | 0 | 39 | 139 | 0 | 203 |
| Colon | 11 | 23 | 0 | 0 | 0 | 0 | 34 |
| Total | 43 | 89 | 78 | 39 | 139 | 52 | 440 |
| | | | | | | | 440 |

The accuracy was computed in 20 realizations of train (75%) and test (25%) datasets using one- and three-item itemsets with the first datasets and the entire combined dataset.

The results are as follows:

GCM (first dataset with 32 samples train, 11 samples test)

Accuracy=0.673±0.130

Combined dataset (330 samples train, 110 test)

Accuracy=0.897±0.027

Length=3 itemsets:

GCM (32 samples train, 11 samples test)

Accuracy=0.623±0.156

Combined dataset (330 samples train, 110 test)

Accuracy=0.921±0.041

The combined confusion matrices for the 20 realizations of train and test are:

GCM dataset

Predicted

| Actual | 0 | 1 | 2 | 3 | | |
|---|---|---|---|---|---|---|
| 0 | 36 | 8 | 20 | 5 | 69 | 33 |
| 1 | 6 | 30 | 12 | 0 | 48 | 18 |
| 2 | 20 | 4 | 29 | 3 | 56 | 27 |
| 3 | 0 | 1 | 4 | 42 | 47 | 5 |
| | 62 | 43 | 65 | 50 | 220 | |

Combined dataset

Accuracy=0.623 (137/220), roc_acc acc.=0.640

Predicted

| Actual | 0 | 1 | 2 | 3 | | |
|---|---|---|---|---|---|---|
| 0 | 561 | 5 | 23 | 1 | 590 | 29 |
| 1 | 30 | 416 | 1 | 0 | 447 | 31 |
| 2 | 77 | 4 | 888 | 24 | 993 | 105 |
| 3 | 5 | 1 | 2 | 162 | 170 | 8 |
| | 673 | 426 | 914 | 187 | 2200 | |

Accuracy=0.921 (2027/2200), roc_acc acc.=0.932

As can be seen in the tables the model has a significant increase in performance when one compares the performance on the first (small) dataset and the combined dataset using all the samples.

The table below shows the cross-validation results using the entire dataset of 440 samples:

Large Bayes (maximum itemset size=1, Naïve Bayes)

| | | Predicted | | | | | |
|---|---|---|---|---|---|---|---|
| | | Breast | Prostate | Lung | Colon | | |
| Actual | | 0 | 1 | 2 | 3 | Total | Errors |
| Breast | 0 | 85 | 0 | 23 | 7 | 115 | 30 |
| Prostate | 1 | 1 | 85 | 1 | 1 | 88 | 3 |
| Lung | 2 | 5 | 0 | 193 | 5 | 203 | 10 |
| Colon | 3 | 0 | 0 | 0 | 34 | 34 | 0 |
| | | 91 | 85 | 217 | 47 | 440 | 43 |

Accuracy=0.902 (397/440), roc_acc acc.=0.914

Large Bayes (maximum itemset size=3)

| | | Predicted | | | | | |
|---|---|---|---|---|---|---|---|
| | | Breast | Prostate | Lung | Colon | | |
| Actual | | 0 | 1 | 2 | 3 | Total | Errors |
| Breast | 0 | 113 | 0 | 2 | 0 | 115 | 2 |
| Prostate | 1 | 7 | 81 | 0 | 0 | 88 | 7 |
| Lung | 2 | 15 | 0 | 187 | 1 | 203 | 16 |
| Colon | 3 | 2 | 0 | 0 | 32 | 34 | 2 |
| | | 137 | 81 | 189 | 33 | 440 | 27 |

Accuracy=0.939 (413/440), roc_acc acc.=0.941

The methodology described in this paper provides a framework for model building across-platforms and with combined datasets. It provides a method to build global classification models that exploit entire databases of gene expression data. These models can be used as part of a central facility to train models (e.g. tumor diagnosis and classification) that can then be deployed to remote locations (hospitals and clinics).

These systems and methods can be realized as a software components operating on a conventional data processing system such as a Unix workstation. In that embodiment, the systems and methods can be implemented as a C language computer program, or a computer program written in any high level language including C++, Fortran, Java or Basic. The development of such programs follows from techniques known to those of skill in the art, and such techniques for high level programming are known, and set forth in, for example, Stephen G. Kochan, Programming in C, Hayden Publishing (1983).

### References

Meretakis, D., Wüthrich, B. (1999a) Extending Naive Bayes classifiers using long itemsets. Proceedings of the Fifth ACM SIGKDD International Conference on Knowledge Discovery and Data Mining (KDD-99), Aug. 15-18, 1999, San Diego pp. 165-174.

Meretakis, D., Wüthrich, B. (1999b) Classification as mining and use of labeled itemsets, In ACM SIGMOD Workshop on Research Issues in Data Mining and Knowledge Discovery (DMKD'99), Philadelphia. Meretakis, D., Lu, H., Wuthrich, B. (2000) A study on the performance of large Bayes classifier. 11th European Conference on Machine Learning (ECML-2000), May 30-Jun. 2, 2000, Barcelona, Spain

Ramakrishnan Srikant, Rakesh Agrawal (1995) Mining Generalized Association Rules Future Generation Computer Systems

### Incorporation by Reference

All publications and patents mentioned herein are hereby incorporated by reference in their entirety as if each individual publication or patent was specifically and individually indicated to be incorporated by reference.

While specific embodiments of the subject invention have been discussed, the above specification is illustrative and not restrictive. Many variations of the invention will become apparent to those skilled in the art upon review of this specification and the claims below. The full scope of the invention should be determined by reference to the claims, along with their full scope of equivalents, and the specification, along with such variations. Thus, those skilled in the art will know or be able to ascertain using no more than routine experimentation, many equivalents to the embodiments and practices described herein. Moreover, the systems and methods described herein may be applied in other domains and to other types of data. For example, the systems and methods described herein may be applied to proteomic data, mRNA data and other kinds of biological data. Further, the methods described herein may be applied to other domains, including analyzing financial data. Additionally, the systems and methods described above may be employed as part of a centralized data depository that allows individuals, universities and other entities to deposit data, such as expression data, into a database that may be employed to generate classifier models as described herein. Accordingly, it will be understood that the invention is not to be limited to the embodiments disclosed herein, but is to be interpreted as broadly as allowed under the law.

1. A method for building classifiers comprising:
merging a plurality of datasets representing data associated with a selected biological system;
processing the datasets to identify an invariant characteristic of the selected biological system, representative of an identifying characteristic of the biological system; and
employing the invariant characteristic to generate a model for classifying datasets or for discovering classes.

2. A method according to claim 1, further comprising
normalizing the plurality of data sets.

3. A method according to claim 1, further comprising
providing a plurality of datasets each being associated with a respective target phenotype.

4. A method according to claim 1, further comprising
scaling the datasets.

5. A method according to claim 1, wherein merging includes
extracting a relative feature of the dataset.

6. A method according to claim 1, wherein merging includes
replacing a dataset value with a column-wise rank value.

7. A method according to claim 1, wherein merging includes
column-wise standardizing dataset values.

8. A method according to claim 1, wherein merging includes
replacing a dataset value with a relative feature representative of a comparison between two or more values in a dataset.

9. A method according to claim 1, further comprising
applying association discovery to identify patterns.

10. A method according to claim 1, further comprising
association discovery to identify itemsets.

11. A method according to claim 1, further comprising
creating a database of patterns.

12. A method according to claim 1, wherein
employing invariant characteristics includes processing a sample data value to determine a probability of association with a target class.

13. A method according to claim 12, wherein determining a probability includes applying a Large Bayes classifier and inference process.

14. A method for building models for diagnosing a disease, comprising:
accessing data from a plurality of remote databases, each having datasets representing data associated with a selected biological system;
processing the datasets to identify and invariant characteristic of the selected biological system, representative of an identifying characteristic of the biological system;
employing the invariant characteristic to generate a model for classifying sample datasets as belonging to a first or second class; and
applying sample data to the generated model to determine whether the sample data is associated with at least one of the first and second classes.

15. A method according to claim 14, wherein
at least one of the first and second classes is representative of a disease state.

16. A system for building classifiers comprising:
a plurality of datasets representing data associated with a selected biological system;
a processor for processing the datasets to identify and invariant characteristic of the selected biological system, representative of an identifying characteristic of the biological system; and
a model generator capable of employing the invariant characteristic to generate a model for associating a sample dataset with a classification.

17. A system according to claim 16, further comprising
a process for applying association discovery to identify patterns within the datasets.

18. A system according to claim 16, further comprising
a process for applying association discovery to identify itemsets within the datasets.

19. A system according to claim 16, further comprising
a database having storage for a set of identified patterns.

20. A system according to claim 16, further comprising
a prediction processor capable of employing invariant characteristics to determine a probability of association between sample data and a target class.

22. A computer readable medium having stored thereon instructions for directing a computer to
merge a plurality of datasets representing data associated with a selected biological system;
process the datasets to identify and invariant characteristic of the selected biological system, representative of an identifying characteristic of the biological system; and
employ the invariant characteristic to generate a model for classifying datasets or for discovering classes.
